(19) United States
(12) Patent Application Publication
(10) Pub. No.: US 2011/0231068 A1
(43) Pub. Date: Sep. 22, 2011

(54) Control apparatus

(76) Inventor: Dennis N. Monahan, Fresno, CA (US)

(21) Appl. No.: 12/661,350

(22) Filed: Mar. 16, 2010

(51) Int. Cl. G06F 19/00

(52) U.S. Cl. 701/50

(57) ABSTRACT

A control apparatus for a work object which has a first and a second mode of operation, the control apparatus having a sensing system operable to detect when the work object is in the first mode; a regulating system operably connected to the sensing system adapted to determine when a predetermined parameter has been reached by the work object; and a control system operably connected to the regulating system to place the work object in the second mode when the regulating system determines that the predetermined parameter has been reached by the work object.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a control apparatus and, more particularly, to a control apparatus which is capable of managing the operation of work objects so as to avoid the unnecessary operation thereof when the work object is not otherwise in use.

(2) Description of the Prior Art

The use of energy of all types has become a focus of attention for a wide variety of concerns. This focus has intensified in recent years due to such issues as the diminishment of reliable sources of energy, the dramatic increases in the cost of energy, the dependence upon sources of energy from foreign venues and the cost of pumping and transporting, for example, oil from remote locations.

Nonetheless, common practices, which often have become engrained, contribute to the unnecessary waste of energy and a concomitant increase in the cost of operating businesses. Such waste is prevalent particularly in industry, farming, construction and the like. For example, in such commerce, bulk materials must frequently be loaded and unloaded using heavy equipment. However, a multiplicity of other operations must also be accomplished as well, frequently without the possibility of scheduling to make such work operations more efficient. In other words, such work operations must be performed almost randomly as the needs arise.

In these environments and many others, large earth moving equipment, wheel loaders, excavators, bulldozers, backhoes, compactors and the like are used to perform large scale tasks. Such heavy equipment, during operation, consumes very large volumes of fuel as compared with lighter equipment, automotive vehicles and the like. Nonetheless, the conventional practice with such heavy equipment, in all of these environments, is to leave the equipment operating; that is, with the engine running when the operator leaves the equipment to attend to the other responsibilities. Characteristically, the other responsibilities take longer than anticipated and, frequently, substantially longer. Often, these tasks are physically distant from the equipment. For these and other reasons, it is inconvenient, or perhaps not possible, to return to the equipment to turn off the engine during such an interruption and delay.

In other instances, the operator leaves the engine and other systems running for such purposes as to leave the air conditioning or heating operating in the operator's compartment of the equipment so as to maintain a comfortable environment therein. Thus, conventional practice is simply to let the engine and subsystems of the equipment continue to run the entire time even though the equipment is not otherwise in use. There are many other environments in which similar situations exist.

This practice, while common, has a host of negative consequences. The most obvious is that fuel consumption for such equipment is substantially greater than would be the case if the engine were run only when the equipment was actually being used for its intended work purpose. Obviously, heavy equipment gets very low gas mileage. In addition, with the dramatic increase in the commercial cost per gallon of fuel, the overall cost of running such business operations is directly adversely affected by this practice. Another direct consequence is that the equipment requires service more frequently than would otherwise be the case. Since the equipment is not moving during such stationary operation, overheating and other adverse consequences can result. Among other things, this may damage the equipment leading to the need for costly repairs. Furthermore, just in general terms, the useable life of the equipment is, to that degree, foreshortened by the unnecessary operation of the engine and other subsystems.

There are also general environmental concerns which result from this practice. In fact, the laws of various jurisdictions prohibit this practice because of general environmental concerns as well as other concerns. More specifically, this practice of letting equipment run has adverse consequences such as the creation of air pollution; the increased risk of fire due to the equipment being stationary, particularly where the equipment overheats; and a multiplicity of other possible hazards too numerous to catalogue.

Therefore, it has long been known that it would be desirable to have a control apparatus which could be operated to manage the use of work objects; which could be operated automatically; which had particular utility when used on mechanical equipment of a heavy duty type; which ensured that equipment which was operating, but not otherwise in use, was controlled so as to avoid the waste of resources, pollution of the environment and other adverse consequences; and which was otherwise entirely successful in achieving its operative purposes.

### BRIEF SUMMARY OF THE INVENTION

Therefore, it is an object of the present invention to provide an improved control apparatus for use on a wide variety of types of work objects.

Another object is to provide such a control apparatus which is operable to manage the use of work objects.

Another object is to provide such a control apparatus which operates substantially, automatically without the need for attention by the operator thereof.

Another object is to provide such a control apparatus which has particular utility in the management of the operation of work objects such as mechanical equipment of a heavy duty type.

Another object is to provide such a control apparatus which prevents continued operation of subsystems of work objects when the work objects are not otherwise in use.

Another object is to provide such a control apparatus which minimizes the adverse environmental consequences from the operation of work objects such as vehicles having internal combustion engines.

Another object is to provide such a control apparatus which permits work objects to be used so as fully to utilize their operative benefits while helping to minimize the expenses associated therewith.

Another object is to provide such a control apparatus which has particular utility in the management of heavy equipment by minimizing fuel consumption, minimizing unnecessary wear upon the operative components thereof, maximizing the warranty protection benefits therefore and the like.

Another object is to provide such a control apparatus which has the capability of permitting the operator of the work object to confirm the status of the work object from a significant distance.

Further objects and advantages are to provide improved elements and arrangements thereof in an apparatus for the purposes described which is dependable, economical, durable and fully effective in accomplishing its intended purposes.

These and other objects and advantages are achieved, in the preferred embodiment of the present invention, in a control apparatus for a work object which has a first mode and a second mode, the control apparatus having a sensing system operable to detect when the work object is in the first mode; a regulating system operably connected to the sensing system adapted to determine when a predetermined parameter has been reached by the work object; and a control system connected to the regulating system whereby the regulating system operates the control system to place the work object in the second mode when the regulating system determines that the predetermined parameter has been reached.

### BRIEF DESCRIPTION OF THE SEVERAL VIEWS OF THE DRAWINGS

FIG. 1 is a fragmentary perspective view of the control apparatus of the present invention showing the upper portion of the microcontroller thereof.

FIG. 2 is a fragmentary perspective view showing the bottom portion of the microcontroller of the control apparatus of FIG. 1.

FIG. 3 is an exploded, fragmentary perspective view of the control apparatus of FIG. 1.

FIG. 4 is a fragmentary side elevation of a heavy piece of equipment, in this case a wheel loader, showing the control apparatus of the present invention in a preferred operational location on the loader.

FIG. 5 is a somewhat enlarged, fragmentary top plan view of a portion of the control apparatus of FIG. 1 and showing the microcontroller thereof.

FIG. 6 is a schematic diagram of a portion of the electrical system of the control apparatus of the present invention and, in particular, showing the microcontroller circuitry and the ignition and accessory relays thereof.

FIG. 7 is a schematic diagram of a portion of the electrical system of the control apparatus of the present invention and, in particular, showing the ignition and accessory relays in addition to connection to certain of the accessories thereof.

FIG. 8 is a schematic diagram of a portion of the electrical system of the control apparatus of the present invention and, in particular, showing the ignition and accessory relays together with descriptive notations relative to the electrical system.

FIG. 9 is a schematic diagram of a portion of the electrical system of the control apparatus of the present invention and, in particular, showing the ignition switch, ignition plug, microcontroller, ignition relay and accessory relay thereof.

FIG. 10 is a schematic diagram of a portion of the electrical system of the control apparatus of the present invention and, in particular showing the microcontroller, ignition relay and ignition and the accessory relay and harness.

### DETAILED DESCRIPTION OF THE INVENTION

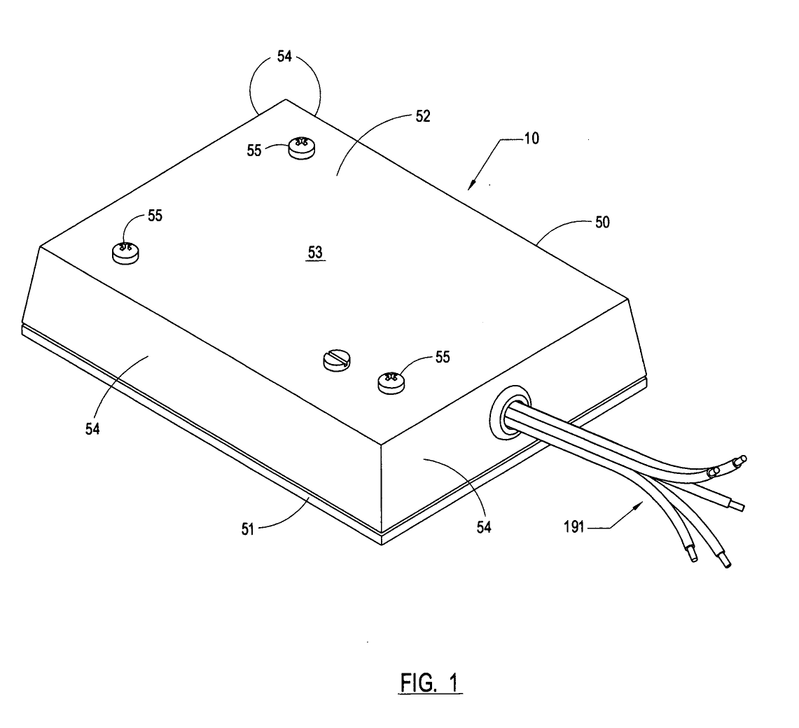

Referring more particularly to the drawings, the apparatus of the present invention in generally indicated by the numeral 10 in FIG. 1.

The control apparatus 10 is adapted for use in conjunction with a wide variety of types of work objects. In most cases, the control apparatus does not have to be modified from the preferred embodiment of the invention hereinafter described in detail. Thus, the control apparatus hereof can be used on all makes and models of wheel loaders, excavators, bulldozers, backhoes, compactors and many other types of heavy equipment as well as other types of equipment. The control apparatus can be used on automotive vehicles such as cars, trucks and the like. It will be understood that this is not a complete list of such work objects, but simply a listing of some examples of such work objects.

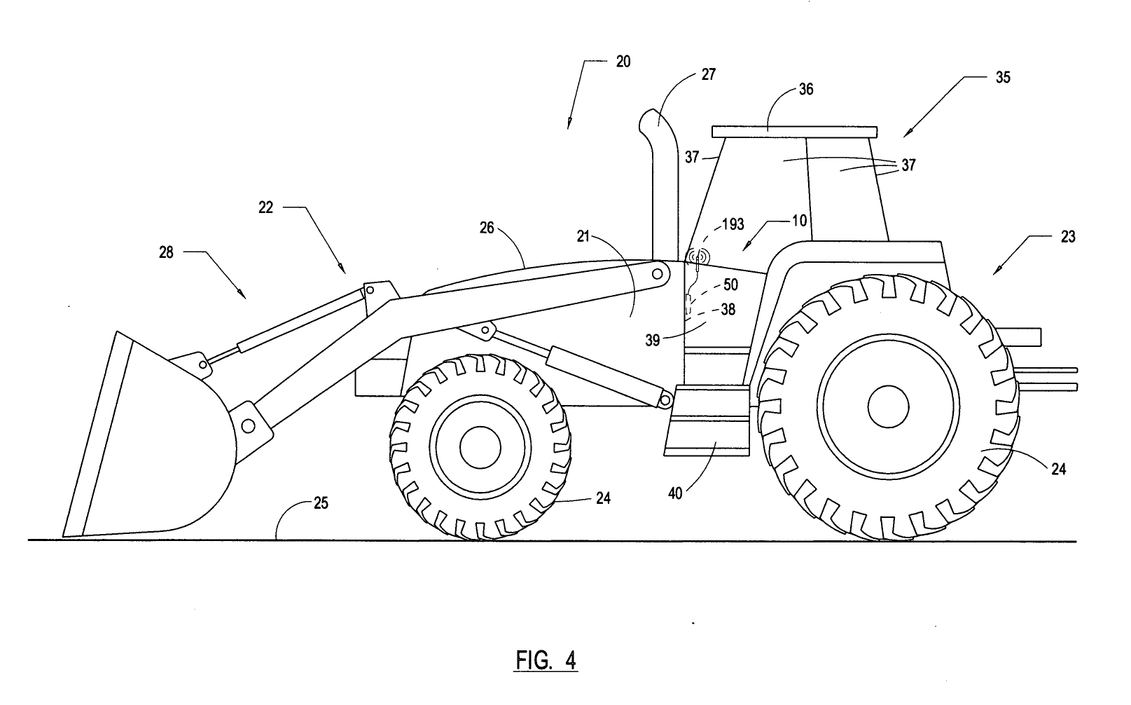

More specifically, in the representative example hereof, the work object is a wheel loader 20 shown in FIG. 4. The wheel loader, in general, has a main frame 21 having a front 22 and a rear 23. The main frame mounts four ground engaging wheels 24 for earth traversing movement across the earth surface 25. The main frame has an engine cowling 26 removably mounted in covering relation to a prime mover; that is, an internal combustion engine, not shown. The engine mounts an upwardly extending exhaust pipe 27. A work bucket or scoop assembly 28 is mounted on the front 22 of the main frame.

The wheel loader 20 has cab or operator's compartment 35 mounted on the main frame 21. The operator's compartment has a roof 36 and glass, or plexiglass, windows 37 which extend entirely around the operator's compartment. An instrument panel 38 of the wheel loader is mounted within the operator's compartment and in close proximity to the engine cowling 26. The operator's compartment has a side door 39 and steps 40 to provide ingress and egress relative to the operator's compartment. The control apparatus 10 of the present invention, as shown and described herein, is operably mounted near the instrument panel 38.

For purposes of illustrative convenience, it will be understood that the wheel loader 20 has a variety of subsystems, not shown, including, for example, a tachometer sensor, a Global Positioning System (GPS) and the like. The wheel loader can have a variety of subsystems, the foregoing simply being illustrative examples thereof.

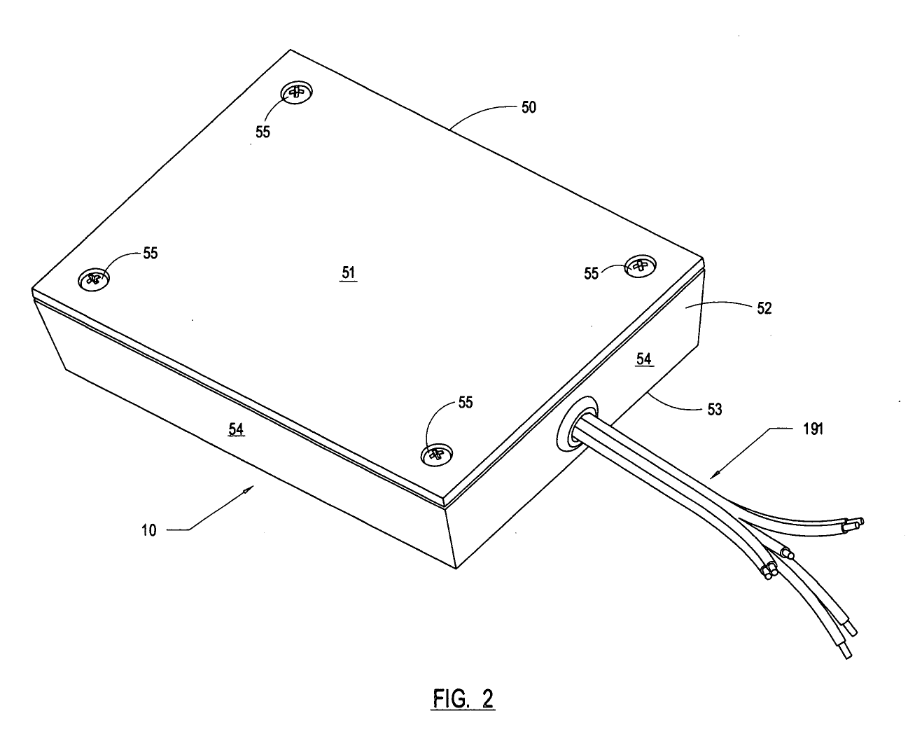

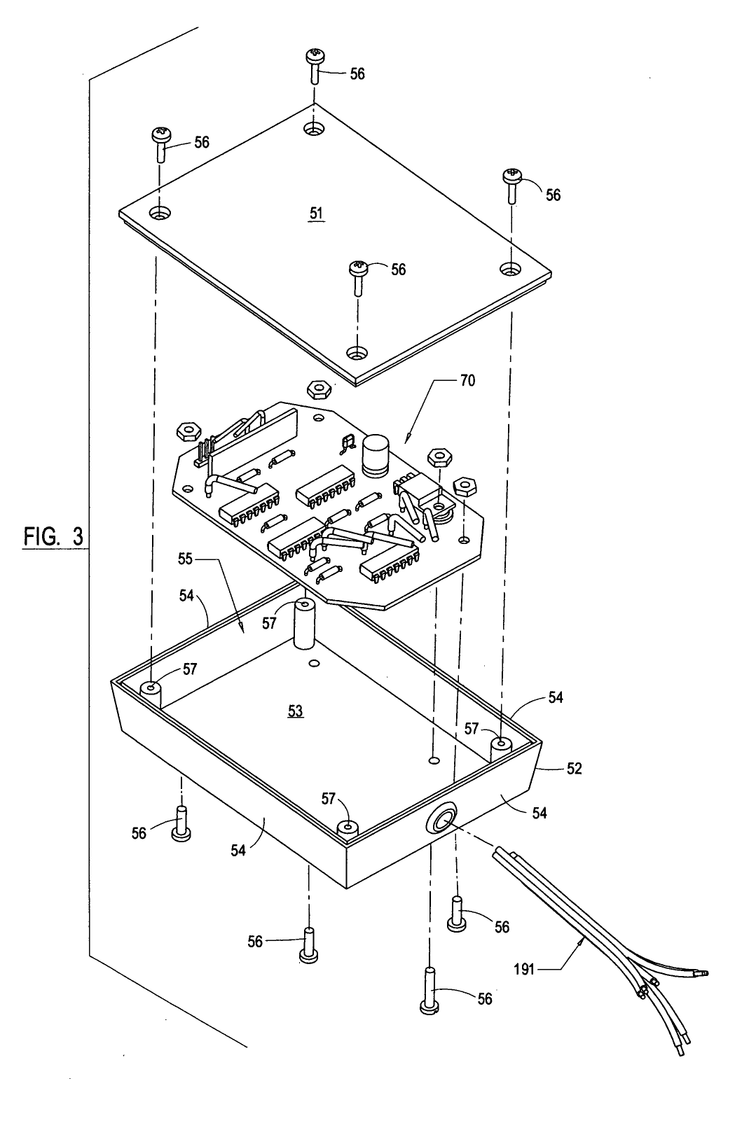

The control apparatus 10 has a microcontroller or main housing 50 shown best in FIGS. 1, 2 and 3. The main housing has a rectangular base plate 51 on which is mounted a top casing 52. The top casing has a rectangular top wall 53 and four (4) sidewalls 54. The main housing has an interior 55, best shown in FIG. 3. The base plate and top casing of the main housing are releasably held together by a plurality of screws 56 which are screwthreadably received in a plurality of corresponding internally screwthreaded holes 57, also as best shown in FIG. 3.

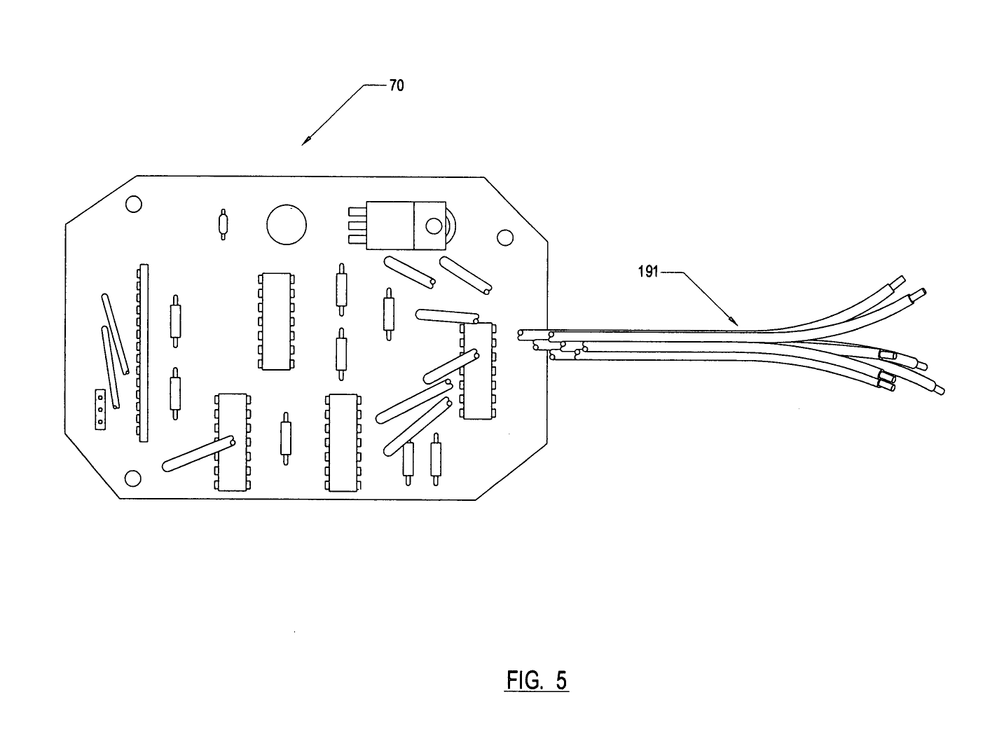

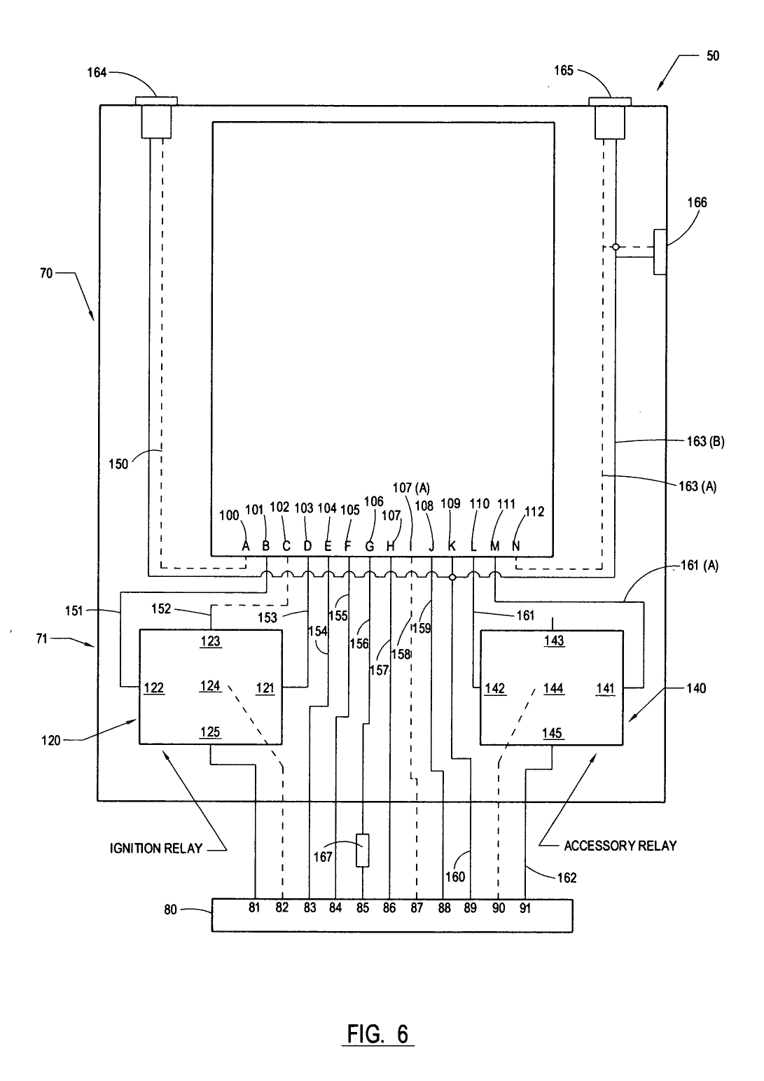

The microcontroller 50 has a circuit board 70 mounted by any suitable means in the interior 55 of the main housing 50 best shown in FIGS. 3 and 5. The circuit board physically contains much of the electrical circuit 71 of the control apparatus 10. The electrical circuit is shown in the schematic diagrams thereof in FIGS. 6, 7, 8, 9, and 10 and will hereinafter be discussed in greater detail.

The electrical circuit 71 is operably connected to certain subsystems of the wheel loader 20. These subsystems of the work object are shown in the schematic diagrams of FIGS. 6, 7, 8, 9 and 10.

Referring first to FIG. 6, the wheel loader 20 has a pin plug connector 80 adapted to have the electrical circuitry connected thereto from the control apparatus 10 to the subsystems of the wheel loader 20. Thus, the wheel loader has an extra connection 81 for use in the event it is required for another subsystem. The pin plug connector also has the following connection locations which, for purposes of illustrative convenience, are listed in serial order: an ignitional relay connection 82 and a transmission neutral switch connection 83 which prevents the control apparatus 10 from shutting down the engine of the wheel loader if the transmission is not in the neutral position. The connection locations of the pin plug connector further include: a park brake connector 84 which operates to prevent the control apparatus 10 from shutting down the engine of the wheel loader if the park brake is not engaged. The control apparatus has a power connection 85 through which the control apparatus receives electrical energy from the battery to operate the control apparatus. The control apparatus has a tachometer sensor connection 86 which provides a pulse to the control apparatus from the wheel loader so as to indicate whether or not the engine of the wheel loader is at a preselected minimum idle speed. An alternator connection can also be employed with or without the tachometer sensor for determining if the engine of the wheel loader is idling in a predefined range.

A Global Positioning System (GPS) connection 87 provides data to the GPS system in the wheel loader if, of course, the wheel loader is equipped with such a system. A ground connection 89 provides an electrical ground for the control apparatus 10 from the wheel loader. An accessory relay connection 90 provides power to the accessory terminal side of the ignition plug to accessory relay 140 at connection post 144. An accessory relay connection 91 provides power from the accessory terminal side of the ignition plug to connection post 145, as will hereinafter be discussed in greater detail.

As shown in FIG. 6, the microcontroller 50 of the control apparatus 10 has a plurality of connections for the performance of its various functions hereinafter set forth. For descriptive conveinence, these connection locations on the main housing are listed in alphabetical order by letter as: (A) lead to red light-emitting diode connection 100; (B) power lead from box connection 101 to ignition relay 120; (C) lead from red light-emitting diode connection 102; (D) information lead 103 from the microcontroller to ignition relay 120; (E) connection lead to transmission neutral switch 104; (F) connection to park brake 105; (G) power connection 106 to microcontroller from work object 20; (H) connection to tachometer sensor 107 from the wheel loader 20; (I) connection to alternator 107(A) from the wheel loader 20; (J) connection to Global Positioning System (GPS) 108; (K) lead to ground 109 of wheel loader 20; (L) power lead from microcontroller connection 110 to accessory relay 140; (M) information lead 111 from the microcontroller to accessory relay 140; and (N) lead to yellow light-emitting diode connection 112.

The microcontroller 50 has an ignition relay generally indicated by the numeral 120 in FIGS. 6, 7, 8 and 9. The ignition relay has an electrical connection 121 and an electrical connection 122. The ignition relay has an electrical connection 123, an electrical connection 124 and an electrical connection 125.

Similarly, the main housing 50 of the control apparatus 10 has an accessory relay 140 shown in FIGS. 6, 7, 8, 9 and 10. The accessory relay has an electrical connection 141 and an electrical connection 142. The accessory relay has an electrical connection 143, an electrical connection 144 and an electrical connection 145.

The main housing 50 of the control apparatus 10 has an electrical conductor 150 interconnecting the (A) power connection 100 to the red light-emitting diode 164. Electrical conductor 151 interconnects (B) power connection 101 and electrical connection 122 of the ignition relay 120. Electrical conductor 152 interconnects (C) 102 and electrical connection 123 of the ignition relay 120. Electrical conductor 153 interconnects (D) 103 and electrical connection 121 of the ignition relay 120. Electrical conductor 154 interconnects (E) 104 and electrical connection 83. Electrical conductor 155 interconnects (F) 105 and electrical connection 84. Electrical conductor 156 interconnects (G) 106 from the microcontroller 50 to electrical connection 85. Electrical conductor 157 interconnects (H) 107 to electrical connection 86. The electrical conductor 158 interconnects (I) 107(A) and electrical connection 87. The electrical conductor 159 interconnects (J) 108 to electrical connection 88 and electrical connection 89. Electrical conductor 160 interconnects (K) from the microcontroller and to a ground connection of the wheel loader. Electrical conductor 161 interconnects (L) 110 and the electrical connection 142 of the accessory relay 140. Electrical conductor 162 interconnects (M) 111 and electrical connection 141 of the accessory relay 140. Electrical conductor 163(A) interconnects (N) 112 and the yellow light-emitting diode 165 and the audible alarm 166 of the control apparatus. Electrical conductor 163(B) interconnects electrical connection (K) and the red light emitting diode 164, the yellow light emitting diode 165 and the buzzer 166.

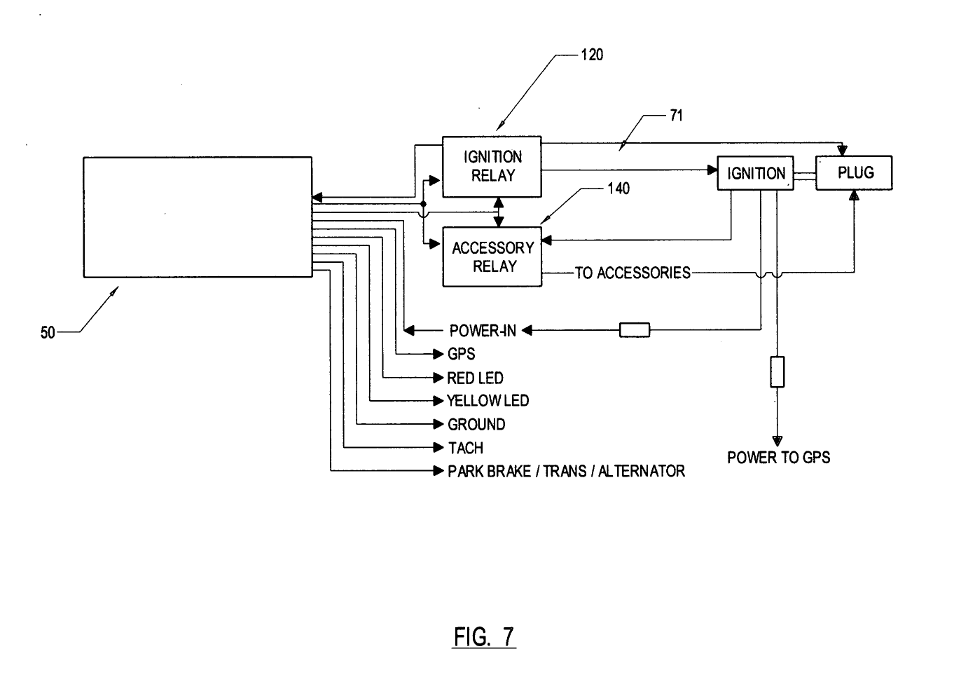

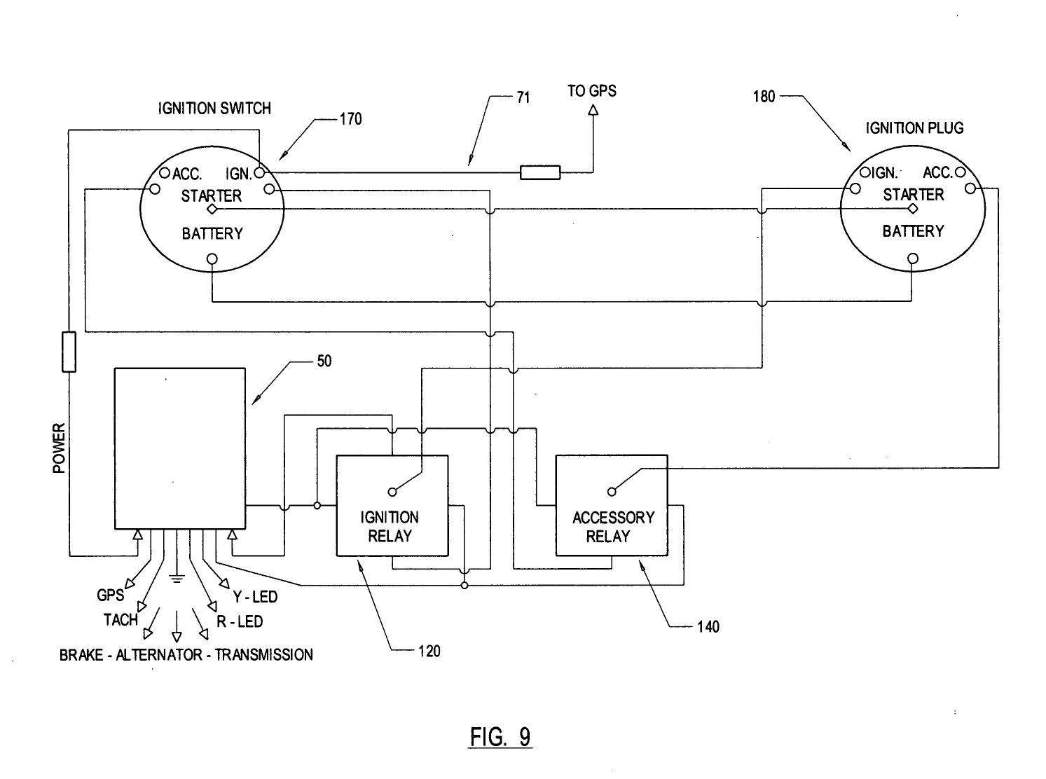

FIGS. 7, 8, 9 and 10 display many of the elements heretofore described and are supplemental views or flow charts further to illustrate the preferred embodiment of the subject invention. Thus, referring more particularly to FIG. 7, the previously described microcontroller 50, ignition relay 120 and accessory relay 140 are shown. In addition, FIG. 7 shows a switch, diagrammatically identified by the numeral 170, and the ignition harness (plug/receptacle) 180. The electrical circuit 71 operably interconnects these elements of the subject invention, as shown in FIG. 9.

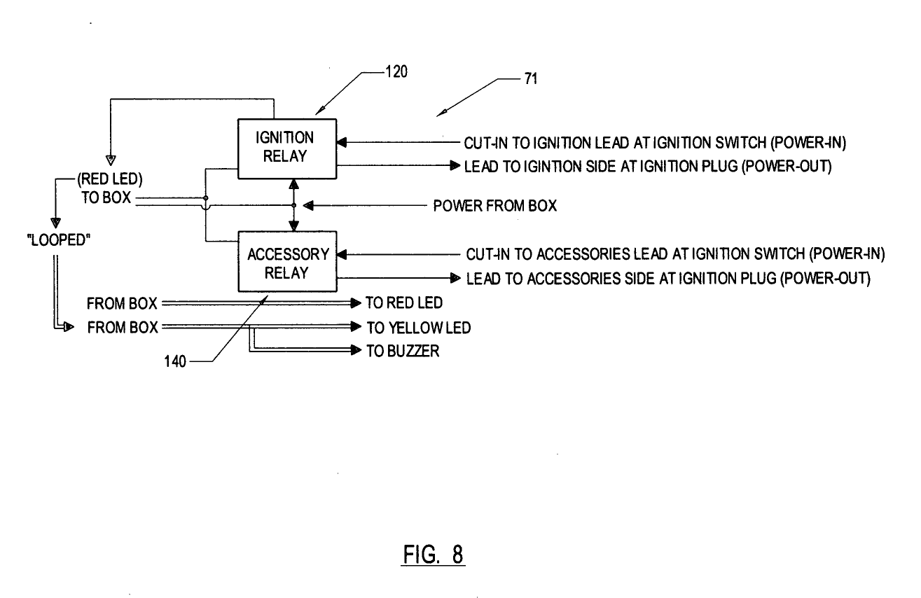

With regard to FIG. 8, the ignition relay 120 and accessory relay 140 are shown operably connected to the electrical circuit 71.

FIG. 9 shows the microcontroller 50, the ignition relay 120, the accessory relay 140 and the ignition switch 170. Also shown in FIG. 9 is ignition harness (plug/receptacle) 180. These elements are operably interconnected by the electrical circuit 71, as shown in FIG. 9.

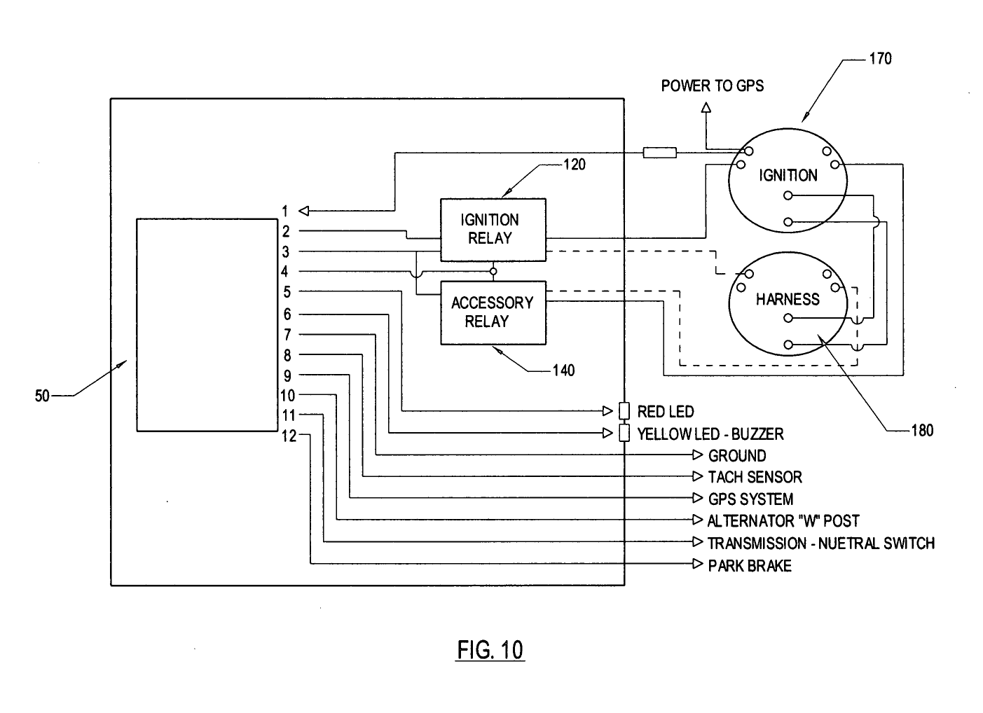

FIG. 10 shows the main housing 50, the ignition relay 120, the accessory relay 140, ignition switch 170 and harness (plug receptacle) 180 all as operably interconnected by the electrical circuit 71.

### Operation

The operation of the described embodiment of the present invention is believed to be readily apparent and is briefly summarized at this point.

In the preferred embodiment of the subject invention, the control apparatus 10, shown and described herein, is mounted on or near the ignition switch assembly of the work object, or in the illustrative example, wheel loader, within the operator's compartment thereof. The control apparatus is so mounted either on the wheel loader when the wheel loader is manufactured and sold as new equipment, or is retrofitted on the work object as an after market product.

The red and yellow light emitting diodes 164 and 165 respectively, as previously discussed, are visible to the operator in the field of operation. The microcontroller 50, as heretofore discussed, is also operably connected to the transmission neutral switch 83; the park brake 84; the power source 85; the tachometer sensor 86; the alternator 87; the Global Positioning System 88; the ground lead to the wheel loader 20, as well as to the other components such as the ignition relay; accessory relay; and the like which enable the control apparatus to perform its various functions.

As heretofore noted, purely for purposes of illustrative convenience, the specific work object is a wheel loader, as shown in FIG. 4. Also for illustrative convenience, the control apparatus may be thought of as being set to shut down the engine of the wheel loader in a range of from one (1) to three (3) minutes from a predesignated starting point, such as when the engine has been in a low idle mode, or first mode, without movement of the wheel loader for a selected period of time, or, for example, after the driver has gotten out of the wheel loader. These considerations are, of course, the decision of the manufacturer.

In some cases, governmental authorities or the like have, or may in the future, proscribe limits in this regard such as, for example, that the engines of certain or all vehicles must not be permitted to idle above a designated number of revolutions per minute for more than a specified period of time, such as five (5) minutes. These are, of course, as a result of largely environmental concerns; that is, preserving natural resources and minimizing air pollution as well as other considerations.

More important to the owner of the equipment, he may be avoiding the costs associated with wasting fuel, exceeding warranty provisions sooner than would otherwise be the case, unnecessary wear on the engine and related systems, and many other such detrimental effects.

The operation of the control apparatus 10 readily avoids the foregoing difficulties. Referring more particularly to FIG. 4, the control apparatus is mounted on or near the instrument panel 38 within the operator's compartment. The microcontroller 50, as heretofore discussed in detail, is also operably connected to the source of power 84, the Global Positioning System 87, the tachometer sensor 88 as well as to the other components as well as the ignition relay, accessory relay, ground and the like which enable the control apparatus to perform its various functions.

The microcontroller 50 monitors the number of revolutions per minute registered by the tachometer sensor. When the number of revolutions per minute is below a preselected number, the microcontroller begins to keep track of the period of time during which this number is continuously below the preselected number.

When a preselected period of time has elapsed, for example three (3) minutes, the microcontroller causes the yellow light-emitting diode 165 to illuminate and activates the audible alarm 166. This serves as a signal to the operator that the engine of the wheel loader is to be shut down as well as the accessories of the wheel loader in a preselected period of time, such as three (3) minutes from the time the yellow light-emitting diode 165 illuminates and the audible alarm 166 is activated. When that preselected period of time has elapsed, the microcontroller through the ignition relay 120 and accessory relay 140 turn off the ignition and the accessories. These components and the engine are thereby shut off. At this time the microcontroller 50 shuts off the yellow light-emitting diode 165 and lights the red light-emitting diode 164. The operator is thereby signaled that all systems including the engine have been shut off by the microcontroller and are therefore in the second mode.

It will be understood that if, during the time period in which the yellow light-emitting diode 165 is illuminated and the audible alarm is activated, the microcontroller detects through the tachometer sensor or the alternator that the number of revolutions per minute of the engine has increased above the preselected lower limit, the microcontroller turns off the yellow light-emitting diode and the audible alarm, discontinues timing for shut down of the engine and accessories and simply monitors operation without keeping track of a period of time. Thus, when the lower limit of the number of revolutions per minute of the engine drops below the lower limit, the process heretofore set forth begins again from the beginning

Therefore, the control apparatus of the present invention can be operated to manage the use of work objects of a wide variety of types; can be operated automatically; has particular utility when used on mechanical equipment of heavy duty size; ensures that equipment which is operating, but not otherwise in use, is controlled so as to avoid the waste of resources, pollution of the environment and other adverse consequences; and is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A control apparatus for a work object which has a first mode and a second mode, said control apparatus comprising a sensing system operable to detect when said work object is in said first mode; regulating means operably connected to said sensing system adapted to determine when a predetermined parameter has been reached by the work object; and a control system connected to said regulating means wherein the regulating means activates the control system to place said work object in said second mode when said regulating means determines that the predetermined parameter has been reached.

2. The control apparatus of claim 1 wherein, in said first mode, the work object is operating and wherein, in said second mode, the work object is not operating.

3. The control apparatus of claim 1 wherein said parameter is the passage of a predetermined period of time.

4. The control apparatus of claim 1 wherein the work object is a prime mover and said parameter is the speed within which the work object is operating in said first mode.

5. The control apparatus of claim 1 wherein said work object is a prime mover, said first mode is when the prime mover is operating and said second mode is when the prime mover is not operating.

6. The control apparatus of claim 1 including a signal operable to indicate when said work object is in said second mode.

7. The control apparatus of claim 6 wherein said signal is a light assembly disposed for visibility remote from said work object to indicate when the work object is in the second mode.

8. The control apparatus of claim 7 wherein said work object is a vehicle having said prime mover and the light assembly discretely indicates when said prime mover is in the first mode and alternatively indicates when the prime mover is in the second mode.

9. The control apparatus of claim 8 wherein the signal light displays one color when the prime mover is in said first mode and a different color when the prime mover is in said second mode.

10. A control apparatus for a vehicle such as an earthworking implement or the like having an engine adapted to be used in at least two modes, a first of said modes being idling for subsequent use and a second of said modes being when said engine is not operating, the control apparatus comprising a sensing system operable discriminately to detect when said engine is in the first mode and in the second mode; a control system, operably connected to said sensing system, to respond to said sensing system detecting when said engine is in the first mode my monitoring for a preselected period of time said idling of the first mode; and a subsystem, operably connected to said control system, for changing operation of said engine from the first mode to said second mode when the control system detects the passage of said preselected period of time.

11. The control apparatus of claim 10 in which said engine is operable within a range of revolutions per minute and wherein during said preselected period of time detected by the control system said revolutions per minute increase above a preselected number, the control system discontinues said monitoring until the engine again operates in the first mode whereupon said monitoring is again begun.

12. The control apparatus of claim 11 wherein a signal light is operably connected to the control system which illuminates the signal light when the engine reaches said second mode.

13. The control apparatus of claim 11 wherein at least one subsystem is operably connected to the control system for control thereby.

14. The control apparatus of claim 11 wherein an audio alarm is operably connected to the control system which produces a sound alarm when the engine approaches said second mode.
